(19) United States
(12) Patent Application Publication
(10) Pub. No.: US 2007/0167206 A1
(43) Pub. Date: Jul. 19, 2007

(54) Method of playing Blackjack with a side wager

(76) Inventor: Michael A. Kirkutis, West Hartford, CT (US)

Correspondence Address: RICHARD L. BIGELOW, 203 TREMONT STREET, NEWINGTON, CT, 06111, US

(21) Appl. No.: 11/332,667

(22) Filed: Jan. 14, 2006

(51) Int. Cl. G06F 19/00

(52) U.S. Cl. 463/11

(57) ABSTRACT

This invention presents methods for playing live and electronic Blackjack-style games with an optional side wager incorporating a bonus or Jackpot feature. The essence of the instant invention is the making of a side bet in the game of Blackjack where the player making the side bet is wagering that he or she will be dealt two Aces, which will then be split and (depending upon casino rules and State Gaming Commission regulations) re-split as additional Aces are dealt, with the ultimate goal of subsequently being dealt ten value cards that will result in “21” when paired with previously dealt Aces. Additional payouts are available if the “21's’ are of a specified rank and suit. This invention presents the opportunity for a unique combination of significant payouts for the player, increased revenue for the casino, and relative simplicity while retaining the basic nature of Blackjack.

### CROSS REFERENCE TO REALTED APPLICATIONS

None

### FEDERAL RESEARCH STATEMENT

None

### FIELD OF THE INVENTION

This invention relates to Blackjack-style games and more particularly to methods for playing live and electronic Blackjack-style games with an optional side wager incorporating a bonus or Jackpot feature.

### BACKGROUND OF THE INVENTION

The prior art reveals a multitude of live and electronic casino card games wherein one or more players are dealt or assemble hands of cards and compete against a hand representing a dealer's hand. One of the most common and popular of such casino card games is the game of Blackjack, which is also referred to as “21.” In the card game of Blackjack, each player makes a wager and the dealer deals two cards to each player to define an initial holding and two cards to himself defining a dealer's initial holding. The cards may be dealt from a single, standard deck of fifty-two playing cards, or from a “shoe” containing multiple decks of cards. The cards to the player(s) may be dealt face up or face down. For the dealer, in the traditional game, one of the dealer's cards in his initial holding is turned face up, which is often referred to as the “up” card, and the other card is dealt face down, which is often referred to as the “hole” card. In the traditional game of Blackjack, the cards have the following arithmetic value:

TABLE 1

| Card | Value |
|---|---|
| Ace | 1 or 11 (at player's option) |
| King | 10 |
| Queen | 10 |
| Jack | 10 |
| 2-10 | card face value |

Each player, in turn, has the opportunity to complete his or her hand in a manner well known in the prior art. The object of the game is for the player to assemble a final hand which (1) has a higher numerical count value than the dealer's final hand without the value exceeding a predetermined target value which, in traditional Blackjack, is 21. In this regard each player may generally exercise the following options:

1. Receiving no additional cards (i.e. “stand”) thereby making the value of the initial holding the player's final holding;

2. Being dealt additional cards (taking “hits”) in order to attempt to achieve or come close to the predetermined target value but at the same time not exceeding the predetermined target value;

3. Doubling the value of his or her initial wager (i.e. “doubling down”) in accordance with the casino's rules;

4. Splitting card pairs of the initial holding into two hands and playing each hand separately;

5. Stopping play of his or her hand (i.e. “surrendering”) and giving up half their wager as permitted and governed by casino rules; and/or.

6. Taking insurance by wagering an amount equal to their game wager and if the dealer has a “Blackjack” or “natural” (initial holding composed of an Ace and a Ten-value card), the player wins 2:1 and therefore, basically, does not win or lose.

Once all the players have completed their hands, the dealer does so as well by taking hits or standing according to the house rules. A variation included in those rules is that the dealer may be required to stand on a “soft 17” (i.e., a hand numerical count of 17 including an Ace which counts as a 1 or an 11). Other rules require the dealer to hit a soft 17.

If a player exceeds the target value of “21”, he or she loses the wager regardless of whether the dealer also exceeds the target value. This is so because the players complete their hands first. If the player's hand does not exceed the target value and (1) his hand has a value exceeding the dealer or (2) the dealer exceeds the target value, the player wins and is paid 1:1 on his or her game wager. If the dealer does not exceed the target value and his hand has a greater value than the player's final hand, the player loses his or her wager. If the player's and the dealer's final hand values are the same, it is a tie (or “push”) and the player neither wins nor loses.

The prior art also reveals computerized games wherein the computer generally assumes the role of the dealer and competes against a player or players. The prior art also reveals hand held, electronic Blackjack.

The rules of traditional Blackjack are somewhat limiting in that the most a player can win is a 3:2 award (i.e. 150% of original wager) which occurs when the player has a natural (i.e. Ace and a ten value card) and the dealer does not have a natural. Therefore, several variations of traditional Blackjack have been developed whereby the potential payouts for players have been increased (thereby making the games more attractive to players) while at the same time increasing potential revenue for the casino.

For example, in U.S. Pat. No. 6,845,981 to Ko, a method for playing Blackjack with a side wager is disclosed. The player wins or loses based upon (1) the dealer's hand exceeding the target value and (2) various parameters involving the dealer's hand and/or the player's hand.

Another example is shown in Griffiths, U.S. Pat. No. 5,174,579. In Griffiths, there is disclosed a Blackjack side wager “21 or over”. The player making this side wager is betting that the dealer will either “bust” (i.e. exceed the value of 21) or achieve exactly a hand count of 21 with 3 or more cards. When the dealer has either busted or achieved an exact hand count of 21, the player is paid according to predetermined odds of 1:1, 3:2 or 2:1. A significant drawback to this wager is the low payoff odds which limit the attractiveness of the game to the player.

There are many Blackjack side wagers that pay much higher payoffs. One such game is known as Lucky Ladies where the top payoff odds are 1000:1 if the player has a hand of Queens of the same suit. Thus “21 or over” won't be enticing or exciting enough for the players. The reason “21 or over” cannot pay odds more than 2:1 is that its hit frequency (probability of the occurrence during play) of 36% is too high. In a “Blackjack game dealt from 6 decks with the “dealer hits a soft 17” rule, a dealer will bust 28.58% of his hands and achieve a count of 21 7.49% of the time. Since the odds are only 1.78:1 against winning a bet with a hit frequency of 36%, there is no way the casino can pay odds higher than 1.78:1, and even with a dealer hand count of 21 being a push, 2.24:1 would be the highest odds the casino can pay without incurring a loss.

Another example is shown in Keller, U.S. Pat. No. 5,816,575, where several side wagers are disclosed, one of which allows the player to bet that the dealer will go bust. When the dealer busts, the player is paid at 5:2 (i.e., 2.5:1) odds. Again, like “21 or over”, the payoff odds for the side wager are unattractive. Furthermore, since the odds against the dealer going bust are only 2.499: 1, the casino won't have an advantage if the side wager is paid 2.5:1. Thus the casino would not have a profit motive for hosting a game with such a side wager.

In Forte, U.S. Pat. No. 5,934,998, there is disclosed a side wager that rewards the player if the number of consecutive dealer bust hands has exceeded a predetermined dealer bust event threshold of 5. The drawback to such a wager is that it not only requires additional equipment such as electronic displays and counters to tally the dealer bust event for every player, but once the dealer starts to bust, the player has to stay and continue to play until the dealer either stops busting or reaches the predetermined threshold. Hence side wagers that cannot be resolved in one single hand or round of play require more supervision and cause inconveniences for the players. Further, because new players may enter the game during the dealer busting sequence, maintaining the tally for each player is difficult and likely to lead to disputes.

In Vancura, U.S. Pat. No. 5,673,917, there is disclosed a side wager for the player to make in addition to his or her base game wager in Blackjack. One embodiment describes the player as making a side wager based upon the number of “hits” the player will take in completing his or her hand. Players are paid for their side wager according to one of several suggested pay tables. One drawback to this game embodiment is that the side wager is either fixed, a percentage of the base wager, or confined within strict limits to counteract the effect of an advantage obtained by professional card counters. When the outcome of a side wager depends on the base wager or is confined within limits determined by the possible effects of card counting in a game where skill can impact the frequency and amount won such as Blackjack, most players will, with respect to the side wager, lose a disproportionate amount of the time. The strategy for this side wager will presumably comprise a set of 2- to N-card strategies, where N equals the maximum winning number of successful hits minus 1 and each multi-card strategy is a matrix composed of “hit or stand” rules based on the player's current hand total of 12 through 20 versus the Ten dealer up cards for a total of 90 rules times (N.times.2)!

Furthermore, since the base wager and the side wager are paid at different odds, the optimal strategy will vary with the ratio of the base wager to to the side wager, thereby necessitating memorizing many more strategy deviations if the player wants to vary their wager size, which they often do. Thus the size of the side wager had better be a fixed amount or fraction of the base wager as stated in his claims 20 to 23.

Another embodiment described in Vancura is that the player may make one or more side wagers where he or she is attempting to predict the exact number of hits the dealer or player will take. If the player incorrectly predicts the exact number, e.g., the player wagers on two hits and the dealer only takes no hits, one hit or three or more hits, the player loses their side wager. There are several drawbacks to this side wager. First, the player must accurately and precisely predict the number of the dealer hits. If he does not so predict, the player loses their side wager. Second, the outcome of the side wager is also dependent upon the player hand. For the side wager where the player is predicting the number of dealer hits, exact prediction is required for the player to win their side wager. For the side wager on the number of player hits there is disclosed an “over” wager, i.e. three or more hits. Second, the outcome of the side wager is also dependent upon the player hand. Also, according to certain disclosed embodiments, if the player receives a natural Blackjack, the side wager is a push. This means the player will not have a chance to win the bet an additional 4.7% of the time (the statistical frequency of player Blackjack(s)). Also, the side wager either pushes or loses if the player exercises one of such options as surrender, double down and splitting. This further deprives the player of their chances to win the side wager an additional 12% of the time. The requirement to precisely predict the dealer's hits and the dependency of the outcome of the side wager on the player hand reduce the frequency that the player will win their side wager. If players do win or see other side wagers won relatively frequently, they may abandon the game or at least the side wager. Further, since precise prediction is required for side wagers based on the dealer's hand, players may become frustrated by infrequent wins of the side wager. As for wagers on the player's hand, often the player will be put into a situation where they must choose between winning their base wager and trying to win their side wager. This creates a stressful situation which may cause casual players to shun the side wager altogether. It is further noted that limiting the side the side wager to ⅕ of the base game wager not only reduces both the excitement and betting action for the player and the revenue for the casino, but it also creates difficulties in calculating the exact bet amount for the player and in calculating and making the payment for the dealer as well when the bet amount is not a multiple of 5. Imagine a player making a base wager of $17.

Another Blackjack-style game is known as “Spanish 21” as revealed in the XXX patent where all the “10s” are removed from the deck. The game plays like standard or normal blackjack although the odds are slightly worse for the player due to the removal of the 10s.

Yet another Blackjack-style game is known as “No Bust 21” or “21.sup.st Century Blackjack” where no hands can “bust.” If the player hand goes over 21, instead of losing their wager immediately as in traditional Blackjack, the player's wager remains in effect until the dealer plays out his hand. Unless the dealer's hand also goes over 21 and is closer to 21 than is the player hand, the player won't lose the wager.

Some Blackjack-style games have been adopted and played which provide for a side (“bonus”) wager that (1) the dealer will have a Blackjack, (2) the dealer's hand will have a certain combination of cards such as suited Queens, or (3) the dealer will take a certain number of hits, or (4) the dealer will bust.

A more recently disclosed method of play is presented in Patent Application No. US2003/0218303 by Walker, et al. The Walker application discloses games whereby a player can make side wagers on future hands.

Another recently disclosed method of play is presented in U. S. Patent Application No. US2003/0222400 by Collins, et al. In Collins, the casino makes the determination which cards may be split. In this case, the player splits Ace—eight hands.

None of the games, patents, or patent applications described above presents the opportunity for the unique combination of significant payouts for the player, increased revenue for the casino, and relative simplicity while retaining the basic nature of Blackjack that the present invention comprises.

### DETAILED DESCRIPTION OF THE INVENTION

The present invention comprises a method of playing Blackjack with an optional side wager. The side bet is made before the dealer begins dealing cards.

The essence of the instant invention is the making of a side bet in the game of Blackjack where the player making the side bet is wagering that he or she will be dealt two Aces, either unsuited or suited, which will then be split and (depending upon casino rules and State Gaming Commission regulations) re-split as additional Aces, either unsuited or suited, are dealt with the ultimate goal of subsequently being dealt ten value cards (which can be of a specified rank and/or suit), that will result in “21” when paired with previously dealt Aces.

Suited Cards and the Minimum Number of Decks Needed for a Created Side Bet Game.

This side bet game begins with the player's goal of being dealt two aces. These aces can be unsuited (which would require a minimum of one deck) or suited (which would require a minimum of two decks). In either case, there is no maximum number of decks. As the process of continuing to allow aces to be split moves forward, additional decks are required in order to present the possibility of obtaining suited aces.

For example, consider a blackjack game which allows aces to be split 3 times for a total of four hands. In order for a player to start with suited aces, split once, split twice and split three times as additional suited aces are received, this would require a minimum of four decks of cards to a maximum of ad infinitum. Similarly, in considering the ten value hit cards to be received on these aces, they can be of a specified rank (for example, jacks) and possibly suited. Because there are choices to be made in this side bet game as to the payout hands and progression of hands, each created side bet game will define, in itself, the minimum number of decks to be used in conjunction with the goal hands to be achieved.

This side bet game in blackjack has been developed for commercial play in a casino environment. One main issue has been to consider the underlying game rules (which vary from casino to casino) of allowing Aces to be split once only or multiple times.

One embodiment of the present invention is to allow the Aces to be split once only. This is referred to as Game 1S (i.e. 1 split). The second embodiment of the invention is to allow multiple splits of Aces. This is referred to as Game 2S (i.e. 2 splits) and Game 3S (i.e. 3 splits).

Game (1S). The side bet game begins with the assumption that Aces are allowed to be split once only. The goal of this side bet game (1 S) is to be a dealt a pair of Aces, either suited or unsuited, split them and the receive two Ten value cards, either suited or unsuited, possibly of a specified rank of ten value cards (Tens, Jacks, Queens, Kings or some combination thereof).

The initial goal of a player who places this side bet is to be dealt two Aces (either suited or unsuited) in the initial two cards. If a player receives the sought after two Aces, the player then automatically splits the two cards (which requires an additional regular wager) and receives only one card per Ace (in most casinos) with the goal of obtaining one or two 21's possibly of a specified rank of Ten value cards (Tens, Jacks, Queens, Kings or some combination thereof) thus getting one or two 21 value hands (otherwise known as blackjack except these hands receive payouts in the ratio of 1 to 1 instead of payouts of 3 to 2 as in normal blackjack). Different types of 21 value hands could have varying payouts. For example, the end goal of one game would be to receive suited Jacks (the preferred Ten value card) on suited split Aces in the same suit as the Aces.

The present invention furthermore anticipates payouts could be made upon attainment of the following:
Game S1. Aces are allowed to be split once only.
   1. Being dealt 1^{st} card ace and 2^{nd} card non-ace.
   2. Being dealt two unsuited Aces.
   3. Being dealt two suited Aces (this requires the use of at least two card decks).
   4. Upon either 2. or 3. above occurring, splitting the Aces and being dealt one or two Ten value cards of a specified rank Ten value cards (i.e. Ten, Jack, Queen, or King or some combination thereof) suited or unsuited, equaling one or two 21 value hands.
   5. A Jackpot hand which for instance could require suited Aces and suited Ten value cards (in the same suit as the Aces) preferably of a specific rank of Ten (i.e. Suited Jack 21 value hands=dealt Ace of hearts, Ace of hearts, Split, dealt Jack of hearts, Jack of hearts which results in a Jackpot). This is possible in any of the four suits.

The method of playing this unique game is exemplified by the following typical example:

### SUPERSPLIT DOUBLEJACK BLACKJACK™ OR SUPERSPLIT DOUBLEJACK 21™

Assumptions:
1. Play blackjack with six standard decks of cards.
2. Dealer allows maximum of one split on a pair of Aces for a total of two hands.
3. Six decks=312 cards, 24 Aces, 24 Jacks, and 96 Ten Value Cards (i.e. 10, Jack, Queen, King)

4. X=non Jack and non-Ace=264, Y=288

TABLE 1
GAME 1S

| | | | | | $Per hand to |
|---|---|---|---|---|---|
| | | Split/ | | | payout based on |
| Step | Description | NO Split | Payout Schedule | Probability | probability. |
| 1 | Place Side Bet of $1 | | | | |
| 2 | 1^{st} two cards dealt: | | | | |
| Either | 1^{st} card Ace and 2^{nd} card | No split | $3. | .071234232 | $.2137 |
| 2.a | non Ace | | | | |
| or 2.b | Two Aces unsuited | Split | $50. | .004192504 | $.2096 |
| or 2.c | Two Aces suited | Split | $100. | .001052342 | $.1052 |
| | (Note: Required for jackpot | | | | |
| | hand) | | | | |
| 3 | If two Aces are received in | | | | |
| | Step 2 (i.e. Step 2.b or Step | | | | |
| | 2.c), Split Aces and each Ace | | | | |
| | is dealt another card. | | | | |
| or 3a. | One Jack 21 | | $200. | .000779337 | $.1559 |
| or 3.b | Two Jack 21s | | $2,000. | .000031337 | $.0627 |
| or 3.c | Jackpot hand. Two Jack | | $100,000. | .000000387 | $.0387 |
| | 21s where Jacks are suited | | | | |
| | and are the same suit as the | | | | |
| | suited Aces(requires suited | | | | |
| | aces). | | | | |
| | TOTAL PER $1 NEEDED | | | | $.7858 |
| | FOR PAYOUTS | | | | |

The payout schedule is based on the use of six decks and a desired casino profit margin of:
$1(side bet)-0.7858(amount payout per hand for all of the payout)=$0.2142

This results in a house edge of 21.42% on each dollar wagered.

The calculations supporting the probabilities and payouts shown above are as follows:

### Supersplit DoubleJack 21

Assumptions:
Playing blackjack with 6 decks
Dealer allows maximum of 1 split on pair of Aces for a total of 2 hands.
6 Decks=312 Cards, Aces=24, Jacks(J)=24, Tens(T)=96, X=264=non Jack and non Ace, Y=288=non Jack, AA=Playable Aces(dealer does not have blackjack) s=suited

$${1}^{st} Card Ace \text{:}$$

$$\begin{matrix}Ace and non ace = 24 / 312 \times 288 / 311 \\ = .076923077 \times .926045016 \\ = .071234232 \underline{or} 1 in 14.04 hands\end{matrix}$$

$$Pair of Aces ( dealer gets blackjack ) \text{:}$$

$$\begin{matrix}\begin{matrix}Ace , Ace , Ace , Ten \underline{or} \\ Ace , Ace , Ten , Ace\end{matrix} = ( 24 / 312 \times 23 / 311 \times 22 / 310 \times 96 / 309 ) \times 2 \\ = ( .076923077 \times .073954984 \times .070967742 \times .310679612 ) \times 2 \\ = ( .000125429 ) \times 2 \\ = .000250858\end{matrix}$$

$$So , Playable Aces ( AA ) = .005688845 - .000250858 = .005437987$$

$$Pair of playable Aces split with no Jack or Ace hit cards \text{:}$$

$$\begin{matrix}\underline{AA} XX = .005437987 \times 264 / 310 \times 263 / 309 \\ = .005437987 \times .851612903 \times .851132686 \\ = .003941646\end{matrix}$$

$$Payout for AA = Pair of aces where dealer gets blackjack + playable aces with$$

$$no Jack or$$

$$Ace hit cards = .000250858 + .003941646 = .004192504 or 1 in 238.52 hands . \\ Pair of Suited Aces with no Jack hit cards \text{:}$$

$$\begin{matrix}AAsYY = 24 / 312 \times 5 / 311 \times 286 / 310 \times 285 / 309 \\ = .076923077 \times .016077170 \times .922580645 \times .922330097 \\ = .001052342 or 1 in 950.26 hands .\end{matrix}$$

$$One Jack 21$$

$$\begin{matrix}\underline{AA} JY , \underline{AA} YJ = ( .005437987 \times 24 / 310 \times 286 / 309 ) \times 2 \\ = ( .005437987 \times .077419355 \times .925566343 ) \times 2 \\ = .000389668 \times 2 \\ = .000779337 or 1 in 1283.14 hands\end{matrix}$$

$$Two Jack 21 s$$

$$\begin{matrix}\underline{AA} JJ = .005437987 \times 24 / 310 \times 23 / 309 \\ = .005437987 \times .077419355 \times .074433657 \\ = .000031337\end{matrix}$$

$$Two Jack 21 s = .000031337 = or 1 in 31 \text{,} 911.16 hands . \\ Two Suited Jack 21 s ( requires AAs to start )$$

$$\begin{matrix}AAsJJs = 24 / 312 \times 5 / 311 \times 6 / 310 \times 5 / 309 \\ = .076923077 \times .016077170 \times .019354839 \times .016181230 \\ = .000000387 or 1 in 2 \text{,} 583 \text{,} 979.33 hands .\end{matrix}$$

Game 2S & 3S. Where Aces are allowed to be split multiple times by a casino, the following occurs:

2X—where the Aces are split twice=three hands are created=game 2S

3X—where the Aces are split three times=four hands are created=game 3S

If a casino allows multiple splitting of Aces, it typically will allow re-splitting Aces 3X for a maximum of four hands to be created. This Game 3S is most commonly found in industry practice, allowing Aces to be split three times for a total of four hands.

Game 2S

The goal of this side bet game is to be dealt a pair of Aces, either suited or unsuited, split them (for the first time) and get additional Aces and Ten Value Cards, either suited or unsuited, possibly of a specified rank of Ten value cards (Tens, Jacks, Queens, Kings or some combination thereof) whereby any additional pair of Aces are split for a second time for a total of three hands with the goal of receiving Ten Value Cards, either suited or unsuited, possibly of a specified rank of Ten Value Cards (Tens, Jacks, Queens, Kings or some combination thereof) for a total of four 21 value hands.

The method of playing game 2S (two splits) is exemplified by the following example;

This game involves receiving two aces, splitting these two aces, receiving an additional ace, in either of the two hit cards, and then receiving jacks as hit cards for each of the three aces that have been dealt.

### SUPERSPLIT TRIPLEJACK 21™ OR SUPER SPLIT TRIPLEJACK BLACKJACK™

TABLE 2
GAME 2S

| | | | | | $ per |
|---|---|---|---|---|---|
| | | Split/ | | | hand to |
| Step | Description | No Split | Payout Schedule | Probability | payout |
| 1 | Place Side Bet of $1 | | | | |
| 2 | 1^{st} two cards dealt: | | | | |
| Either | 1^{ST} card ace and 2^{nd} card | No split | $3. | .071234232 | $.2137 |
| 2.a | non-ace. | | | | |
| or 2.b | Two Aces | Split | $50. | .004192504 | .2096 |
| 3 | If two Aces received in Step | | | | |
| | 2b Split Aces(split #1) and | | | | |
| | each Ace is dealt another | | | | |
| | card with hit cards being | | | | |
| | jacks and/or another | | | | |
| | ace(split #2) with jack hit | | | | |
| | cards. | | | | |
| or 3.a | One Jack 21 | | $200. | .000843898 | $.1688 |
| or 3.b | Two Jack 21s | | $2,000. | .000037572 | $.0751 |
| 3.c | Three Jack 21s | | $100,000.00 | .000000321 | $.0321 |
| | TOTAL PER $1 NEEDED | | | | .6993 |
| | FOR PAYOUTS. | | | | |

The payout schedule is based on the use of six decks and a desired casino profit margin of:
$1(side bet)—0.6993(amount payout per hand for all of the payout)=$0.3007.

This results in a house edge of 30.07% on each dollar wagered.

All payouts are non-cumulative. Player is paid out at highest payout achieved. A pair of aces split once is required for all Jack 21 payouts. A second pair of aces must be received and split to have the possibility of three Jack 21s.

The calculations supporting the probabilities and payouts shown above are as follows:

### Supersplit TripleJack 21

Assumptions:
Playing blackjack with 6 decks
Dealer allows maximum of 2 splits on pair of Aces for a total of 3 hands.
6 Decks=312 Cards, Aces=24, Jacks(J=24, Tens(T)=96, X=264=non Jack and non Ace, Y=288=non Jack, AA=Playable Aces(dealer does not have blackjack)

$${1}^{st} Card Ace \text{:}$$

$$\begin{matrix}Ace and non ace = 24 / 312 \times 288 / 311 \\ = .076923077 \times .926045016 \\ = .071234232 or 1 in 14.04 hands\end{matrix}$$

$$Pair of Aces ( dealer gets blackjack ) \text{:}$$

$$\begin{matrix}\begin{matrix}Ace , Ace , Ace , Ten \underline{ or} \\ Ace , Ace , Ten , Ace\end{matrix} = ( 24 / 312 \times 23 / 311 \times 22 / 310 \times 96 / 309 ) \times 2 \\ = ( .076923077 \times .073954984 \times .070967742 \times .310679612 ) \times 2 \\ = ( .000125429 ) \times 2 \\ = .000250858\end{matrix}$$

$$So , Playable Aces ( AA ) = .005688845 - .000250858 = .005437987$$

$$Pair of playable Aces split with no Jack or Ace hit cards \text{:}$$

$$\begin{matrix}\underline{AA} XX = .005437987 \times 264 / 310 \times 263 / 309 \\ = .005437987 \times .851612903 \times .851132686 \\ = .003941646\end{matrix}$$

$$\begin{matrix}Payout for AA = Pair of aces where dealer gets blackjack + \\ playable aces with no Jack or Ace hit cards \\ = .000250858 + .003941646 \\ = .004192504 or 1 in 238.52 hands .\end{matrix}$$

$$One Jack 21$$

$$\begin{matrix}\underline{AA} JX AND \underline{ AA} XJ = ( .005437987 \times 24 / 310 \times 264 / 309 ) \times 2 \\ = ( .005437987 \times .077419355 \times .854368932 ) \times 2 \\ = ( .000359694 ) \times 2 \\ = .000719388\end{matrix}$$

$$\begin{matrix}\begin{matrix}\underline{AA} XAJY , \\ \underline{AA} XAYJ\end{matrix} = .005437987 \times 264 / 310 \times 22 / 309 \times 24 / 308 \times 284 / 307 + \\ .005437987 \times 264 / 310 \times 22 / 309 \times 284 / 308 \times 24 / 307 \\ = ( .005437987 \times 264 / 310 \times 22 / 309 \times 24 / 308 \times 284 / 307 ) \times 2 \\ = ( .005437987 \times .851612903 \times .071197411 \times .077922078 \times .925081433 ) \times \\ 2 \\ = .000023768 \times 2 \\ = .000047535\end{matrix}$$

$$\begin{matrix}\begin{matrix}\underline{AA} AYYJ , \\ \underline{AA} AYJY , \\ \underline{AA} AJYY\end{matrix} = ( .005437987 \times 22 / 310 \times 24 / 309 \times 285 / 308 \times 284 / 307 ) \times 3 \\ = ( .005437987 \times .070967742 \times .077669903 \times .925324675 \times .925081433 ) \times \\ 3\end{matrix}$$

$$Proprietary and confidential . Copyright 2005 Michael A . Kirkutis \\ = .000025658 \times 3 = .000076975$$

$$One 21 = .000719388 + .000047535 + .000076975 = .000843898$$

$$Or 1 in 1184.98 hands$$

$$Two Jack 21 s$$

$$\begin{matrix}\underline{AA} JJ = .005437987 \times 24 / 310 \times 23 / 309 \\ = .005437987 \times .077419355 \times .074433657 \\ = .000031337\end{matrix}$$

$$\begin{matrix}\begin{matrix}\underline{AA} AJJY , \\ \underline{AA} AJYJ , \\ \underline{AA} AYJJ\end{matrix} = ( .005437987 \times 22 / 310 \times 24 / 309 \times 23 / 308 \times 285 / 307 ) \times 3 \\ = ( .005437987 \times .070967742 \times .077669903 \times .074675325 \times .928338762 ) \times 3 \\ = .000002078 \times 3 \\ = .000006234\end{matrix}$$

$$Two Jack 21 s = .000031337 + .000006235 = .000037572 or 1 in 26615.56 hands . \\ Three Jack 21 s \text{:}$$

$$\begin{matrix}\begin{matrix}\underline{AA} JAJJ \\ or \\ \underline{AA} AJJJ\end{matrix} = ( .005437987 \times 24 / 310 \times 22 / 309 \times 23 / 308 \times 22 / 307 ) \times 2 \\ = ( .005437987 \times .077419355 \times .071197411 \times .074675325 \times .071661238 ) \times 2 \\ = ( .000000160 ) \times 2 \\ = .000000321 or 1 in 3 \text{,} 115 \text{,} 264.80 hands\end{matrix}$$

Game 3S

The goal of this side bet game is to be dealt a pair of Aces, either suited or unsuited, split them (for the first time) and get additional Aces and Ten Value Cards, either suited or unsuited, preferably of a specified rank of Ten value cards (Tens, Jacks, Queens, Kings or some combination thereof) whereby any additional pair of Aces are split for a second and third time for a total of four hands with the goal of receiving Ten Value Cards, either suited or unsuited, possibly of a specified rank of Ten Value Cards (Tens, Jacks, Queens, Kings or some combination thereof) for a total of four 21 value hands.

The method of playing game 3S (three splits) is exemplified by the following example:

The goal of this side bet game is to be dealt a pair of Aces, split them (for the first time) and get additional Aces and Jacks, whereby any additional pair of Aces are split for a second and third time for a total of four hands with the goal of receiving Jack hit cards, for a total of four Jack 21 value hands.

### SUPERSPLIT QUADRUPLE 21™ or SUPERSPLIT QUADRUPLE BLACKJACK™

Aces are allowed to be split three times for a maximum number of four hands.

TABLE 3
GAME 3S

| | | Split/ | | | $ per hand |
|---|---|---|---|---|---|
| Step | Description | No Split | Payout Schedule | Probability | to payout |
| 1 | Place Side Bet of $1 | | | | |
| 2 | 1^{st} two cards dealt: | | | | |
| Either | 1^{ST} card ace and 2^{nd} | No split | $3. | .071234232 | $.2137 |
| 2.a | card non-ace. | | | | |
| or 2.b | Two Aces | Split | $50. | .004192504 | .2096 |
| 3 | If two Aces received in | | | | |
| | Step 2b Split Aces(split | | | | |
| | #1) and each Ace is dealt | | | | |
| | another card with hit cards | | | | |
| | being jacks and/or another | | | | |
| | 2 aces(split #2 and split | | | | |
| | #3) with jack hit cards. | | | | |
| or 3.a | One Jack 21 | | $200. | .000843898 | $.1701 |
| or 3.b | Two Jack 21s | | $2,000. | .000037572 | $.0831 |
| 3.c | Three Jack 21s | | $100,000.00 | .000000321 | $.0526 |
| 4.c | Four Jack 21s. | | $1,000,000.00 | .000000004 | $.0040 |
| | Total per $1 needed for | | | | $.7331 |
| | payouts | | | | |

The payout schedule is based on the use of six decks and a desired casino profit margin of:
$1 (side bet)—0.7331 (amount payout per hand for all of the payout)=$0.2669

This results in a house edge of 26.69% on each dollar wagered.

The calculations supporting the probabilities and payouts shown above are as follows:

### Supersplit OuadrupleJack 21

Assumptions:
Playing blackjack with 6 decks
Dealer allows maximum of 3 splits on pairs of Aces for a total of 4 hands.
6 Decks=312 Cards, Aces=24, Jacks(J)=24, Tens(T)=96, X=264=non Jack and non Ace, Y=288=non Jack, AA=Playable Aces(dealer does not have blackjack)

$${1}^{st} Card Ace \text{:}$$

$$\begin{matrix}Ace and non ace = 24 / 312 \times 288 / 311 \\ = .076923077 \times .926045016 \\ = .071234232 or 1 in 14.04 hands\end{matrix}$$

$$Pair of Aces ( dealer gets blackjack ) \text{:}$$

$$\begin{matrix}\begin{matrix}Ace , Ace , Ace , Ten \underline{or} \\ Ace , Ace , Ten , Ace\end{matrix} = ( 24 / 312 \times 23 / 311 \times 22 / 310 \times 96 / 309 ) \times 2 \\ = ( .076923077 \times .073954984 \times .070967742 \times .310679612 ) \times 2 \\ = ( .000125429 ) \times 2 \\ = .000250858\end{matrix}$$

$$So , Playable Aces ( AA ) = .005688845 - .000250858 = .005437987$$

$$Pair of playable Aces split with no Jack or Ace hit cards \text{:}$$

$$\begin{matrix}\underline{AA} XX = .005437987 \times 264 / 310 \times 263 / 309 \\ = .005437987 \times .851612903 \times .851132686 \\ = .003941646\end{matrix}$$

$$\begin{matrix}Payout for AA = Pair of aces where dealer gets blackjack + \\ playable aces with no Jack or Ace hit cards \\ = .000250858 + .003941646 = .004192504 or 1 in 238.52 hands .\end{matrix}$$

$$One Jack 21$$

$$\begin{matrix}\underline{AA} JX AND \underline{AA} XJ = ( .005437987 \times 24 / 310 \times 264 / 309 ) \times 2 \\ = ( .005437987 \times .077419355 \times .854368932 ) \times 2 \\ = ( .000359694 \times 2 ) \\ = .000719388\end{matrix}$$

$$\begin{matrix}\begin{matrix}\underline{AA} XAJY , \\ \underline{AA} XAYJ\end{matrix} = .005437987 \times 264 / 310 \times 22 / 309 \times 24 / 308 \times 284 / 307 + \\ .005437987 \times 264 / 310 \times 22 / 309 \times 284 / 308 \times 24 / 307 \\ = ( .005437987 \times 264 / 310 \times 22 / 309 \times 24 / 308 \times 284 / 307 ) \times 2 \\ = ( .005437987 \times .851612903 \times .071197411 \times .077922078 \times .925081433 ) \times \\ 2 \\ = .000023768 \times 2 \\ = .000047535\end{matrix}$$

$$\begin{matrix}\begin{matrix}\underline{AA} AYYJ , \\ \underline{AA} AYJY , \\ \underline{AA} AJYY\end{matrix} = ( .005437987 \times 22 / 310 \times 24 / 309 \times 285 / 308 \times 284 / 307 ) \times 3 \\ = ( .005437987 \times .070967742 \times .077669903 \times .925324675 \times .925081433 ) \times \\ 3 \\ = .000025658 \times 3 \\ = .000076975\end{matrix}$$

$$\begin{matrix}\underline{AA} AAJYYY \times 20 = ( \begin{matrix}.005437987 \times 22 / 310 \times 21 / 309 \times 24 / 308 \times 284 / 307 \times \\ 283 / 306 \times 282 / 305\end{matrix} ) \times 4 \\ = ( \begin{matrix}.005437987 \times .070967742 \times .067961165 \times .077922078 \times \\ .925081433 \times .924836601 \times .924590164\end{matrix} ) \times 4 \\ = .000001617 \times 4 \\ = .000006467\end{matrix}$$

$$\begin{matrix}One Jack 21 = .000719388 + .000047535 + .000076975 + .000006467 \\ = .000850365 or 1 in 1175.97 hands .\end{matrix}$$

$$Two Jack 21 s$$

$$\begin{matrix}\underline{AA} JJ = .005437987 \times 24 / 310 \times 23 / 309 \\ = .005437987 \times .077419355 \times .074433657 \\ = .000031337\end{matrix}$$

$$\begin{matrix}\begin{matrix}\underline{AA} AJJY , \\ \underline{AA} AJYJ , \\ \underline{AA} AYJJ\end{matrix} = ( .005437987 \times 22 / 310 \times 24 / 309 \times 23 / 308 \times 285 / 307 ) \times 3 \\ = ( .005437987 \times .070967742 \times .077669903 \times .074675325 \times .928338762 ) \times 3 \\ = .000002078 \times 3 \\ = .000006234\end{matrix}$$

$$\begin{matrix}\underline{AA} AAJJYY \times 30 = ( \begin{matrix}.005437987 \times 22 / 310 \times 21 / 309 \times 24 / 308 \times \\ 23 / 307 \times 284 / 306 \times 283 / 305\end{matrix} ) \times 30 \\ = ( \begin{matrix}.005437987 \times .070967742 \times .067961165 \times .077922078 \times \\ .074918567 \times .928104575 \times .927868853\end{matrix} ) \times 30 \\ = .00000132 \times 30 \\ = .000003956\end{matrix}$$

$$\begin{matrix}Two Jack 21 s = .000031337 + .000006235 + .000003956 \\ = .000041528 or 1 in 24 \text{,} 080.14 hands .\end{matrix}$$

$$Three Jack 21 s \text{:}$$

$$\begin{matrix}\begin{matrix}\underline{AA} JAJJ \\ or \\ \underline{AA} AJJJ\end{matrix} = ( .005437987 \times 24 / 310 \times 22 / 309 \times 23 / 308 \times 22 / 307 ) \times 2 \\ = ( .005437987 \times .077419355 \times .071197411 \times .074675325 \times .071661238 ) \times 2 \\ = ( .000000160 ) \times 2 \\ = .000000321\end{matrix}$$

$$\begin{matrix}\underline{AA} AAJJJY = ( \begin{matrix}.005437987 \times 22 / 310 \times 21 / 309 \times 24 / 308 \times 23 / 307 \times \\ 22 / 306 \times 284 / 305\end{matrix} ) \times 20 \\ = ( \begin{matrix}.005437987 \times .070967742 \times .067961165 \times .077922078 \times \\ .074918567 \times .071895425 \times .931147541\end{matrix} ) \times 20 \\ = 000000010 \times 20 \\ = .000000205\end{matrix}$$

$$\begin{matrix}Three Jack 21 s = .000000321 + .000000205 \\ = .000000526 or 1 in 1 \text{,} 401 \text{,} 140.68 hands .\end{matrix}$$

$$Four Jack 21 s \text{:}$$

$$\begin{matrix}\underline{AA} AAJJJJ = ( \begin{matrix}.005437987 \times 22 / 310 \times 21 / 309 \times 24 / 308 \times 23 / 307 \times \\ 22 / 306 \times 21 / 305\end{matrix} ) \times 5 \\ = ( \begin{matrix}.00547987 \times .070967742 \times .067961165 \times .077922078 \times \\ .074918567 \times .071895425 \times .068852459\end{matrix} ) \times 5 \\ = .000000004\end{matrix}$$

$$Four Jack 21 s = .000000004 or 1 in 250 \text{,} 000 \text{,} 000.00 hands .$$

The following is claimed:

1. A method of playing a computerized or live card game with a dealer, at least one player, and one standard deck of cards comprising the steps of:
a. a player placing a bet for a standard Blackjack game wherein aces are allowed to be split once only,
b. the same player as in (a) above placing an additional side bet with the goal of being dealt two aces,
c. if two aces are dealt to the player in (b), the player splits those two aces (split no. 1) into two separate hands, and then is dealt an additional card for each of the two split hands and continues playing Blackjack in each of said two separate hands,
d. if ten value cards are dealt to the player in (c) above, the casino pays off according to a pre-established scheme for each hand that is a combination of an ace and a ten value card.

2. A method of playing a computerized or live card game as in claim 1 using two or more standard decks of cards.

3. A method of playing a computerized or live card game as in claim 1 where the aces and ten value cards are of the same suit.

4. A method of playing a computerized or live card game as in claim 1 using two or more standard decks of cards where the aces and ten value cards are of the same suit.

5. A method of playing a computerized or live card game with a dealer, at least one player, and one standard deck of cards comprising the steps of:
a. a player placing a bet for a standard Blackjack game wherein aces are allowed to be split twice,
b. the same player as in (a) above placing an additional side bet with the goal of being dealt two aces,
c. if two aces are dealt to the player in (b), the player splits those two aces (split no. 1) into two separate hands, and then is dealt an additional card for each of the two split hands and continues playing Blackjack in each of said two separate hands,
d. if ten value cards are dealt to the player in (c) above, the casino pays off according to a pre-established scheme for each hand that is a combination of an ace and a ten value card,
e. if an additional ace is received by the player in (c) above, it is split (split no. 2) into two separate hands, and the player is dealt an additional card for each of the two split hands and continues playing Blackjack in each of the said two separate hands,
f. if ten value cards are dealt to the player in (e) above, the casino pays off according to a pre-established scheme for each hand that is a combination of an ace and a ten value card.

6. A method of playing a computerized or live card game as in claim 5 using three or more standard decks of cards.

7. A method of playing a computerized or live card game as in claim 5 where the aces and ten value cards are of the same suit.

8. A method of playing a computerized or live card game as in claim 5 using three or more standard decks of cards where the aces and ten value cards are of the same suit.

9. A method of playing a computerized or live card game with a dealer, at least one player, and one standard deck of cards comprising the steps of:
a. a player placing a bet for a standard Blackjack game wherein aces are allowed to be split three times,
b. the same player as in (a) above placing an additional side bet with the goal of being dealt two aces,
c. if two aces are dealt to the player in (b), the player splits those two aces (split no. 1) into two separate hands, and then is dealt an additional card for each of the two split hands and continues playing Blackjack in each of said two separate hands,
d. if ten value cards are dealt to the player in (c) above, the casino pays off according to a pre-established scheme for each hand that is a combination of an ace and a ten value card,
e. if additional aces are received by the player in (c) above, it is split (split no. 2) into two separate hands, and the player is dealt an additional card for each of the two split hands and continues playing Blackjack in each of the said two separate hands,
f. if ten value cards are dealt to the player in (e) above, the casino pays off according to a pre-established scheme for each hand that is a combination of an ace and a ten value card.
g. if additional aces are received by the player in (e) above, it is split (split no. 3) into two separate hands, and the player is dealt an additional card for each of the two split hands and continues playing Blackjack in each of the said two separate hands,
h. if ten value cards are dealt to the player in (f) above, the casino pays off according to a pre-established scheme for each hand that is a combination of an ace and a ten value card.

10. A method of playing a computerized or live card game as in claim 9 using four or more standard decks of cards.

11. A method of playing a computerized or live card game as in claim 9 where the aces and ten value cards are of the same suit.

12. A method of playing a computerized or live card game as in claim 9 using four or more standard decks of cards where the aces and ten value cards are of the same suit.
